(19) United States
(12) Patent Application Publication
(10) Pub. No.: US 2025/0278537 A1
(43) Pub. Date: Sep. 4, 2025

(54) INTELLIGENT OPTIMIZATION METHOD FOR WELDED BEAM

(71) Applicant: Taiyuan University of Science and Technology, Taiyuan (CN)

(72) Inventors: Hongjuan Li, Taiyuan (CN); Xiaofei Mu, Taiyuan (CN); Lidong Zhou, Taiyuan (CN); Yanping Yao, Taiyuan (CN); Shaohui Ning, Taiyuan (CN); Yuan Yuan, Taiyuan (CN); Zhiwu Wang, Taiyuan (CN); Pengfei Zhang, Taiyuan (CN); Jiang Zhi, Taiyuan (CN); Biaobiao Guo, Taiyuan (CN); Junyang Ma, Taiyuan (CN)

(21) Appl. No.: 19/019,490

(22) Filed: Jan. 14, 2025

(30) Foreign Application Priority Data
Mar. 4, 2024 (CN) 202410243181.4

(51) Int. Cl. G06F 30/20; G06F 119/18

(52) U.S. Cl. CPC G06F 30/20; G06F 2119/18

(57) ABSTRACT

An intelligent optimization method for welded beam includes the following steps: utilizing a Bernoulli map from a chaotic map to replace an original random population generation method; optimizing a linear decay pattern of Pal in a first strategy of NOA into a nonlinear decay pattern; applying Brownian motion strategy and Levy flight strategy to perform a position update of reference points PR₁ and PR₂ in a second strategy; and incorporating the sine cosine operator into the position updates of the second strategy. The method utilizes MATLAB software for programming, analyzing the original NOA algorithm and BSCNOA, and compares their optimization effects with GWA, WOA, and PSO. The results of the BSCNOA show better performance. The method addresses the shortcomings of the Nutcracker Algorithm and applies the proposed algorithm to the optimization problem of welded beam, significantly reducing the cost of welded beam.

### CROSS-REFERENCE TO RELATED APPLICATION

This application claims priority to Chinese patent application No. CN 202410243181.4, filed to China National Intellectual Property Administration (CNIPA) on Mar. 4, 2024, which is herein incorporated by reference in its entirety.

### TECHNICAL FIELD

The disclosure relates to the technical field of welded beams, and particularly to an intelligent optimization method for welded beams.

### BACKGROUND

A design problem of welded beams is one of the many engineering problems that aim to minimize costs of welded beams, characterized by multiple constraints and nonlinearity. Current research stages have seen algorithms such as Genetic Algorithms (GA), Particle Swarm Optimization (PSO), Whale Optimization Algorithm (WOA), Grey Wolf Optimizer (GWO), and Chimp Optimization Algorithm (ChOA) being used to solve this problem, but the design solutions obtained from these optimization algorithms still require further refinement.

Nutcracker Optimization Algorithm (NOA), proposed by Mohamed Abdel-Basse and others in 2023, is a novel nature-inspired intelligent optimization algorithm based on two distinct behaviors exhibited by nutcrackers from the Clark region at different times. The NOA simulates two behaviors with both exploration and exploitation phases in foraging and storage strategies, as well as caching search and retrieval strategies. Compared to other intelligent optimization algorithms, the NOA has three major characteristics: first, the NOA is easy to implement; second, it has a high convergence speed; and third, it is applicable to a variety of optimization problems with different characteristics. However, the NOA still faces challenges such as a tendency to get stuck in low-precision optimization and an inability to balance the exploration and exploitation phases according to the needs of the optimization problem, which could save computational costs and avoid falling into local optimal traps.

### SUMMARY

In response to the technical problems of the original NOA, which is prone to low optimization accuracy and unable to balance the exploration and exploitation phases according to the needs of the optimization problem, thus falling into the trap of local optima, the disclosure provides an intelligent optimization method for welded beams. By employing a hybrid strategy to improve the NOA, the improved algorithm significantly reduces the cost of welded beams.

To solve the above problem, the technical solutions of the disclosure are as follows.

An intelligent optimization method for welded beams includes steps as follows:
S1, initializing a nutcracker population by using a Bernoulli map to ensure a uniform distribution of the nutcracker population;
S2, calculating a fitness of each individual in the nutcracker population based on positions generated by the Bernoulli map and selecting an optimal position in the positions generated by the Bernoulli map;
S3, randomly generating two values of σ, σ₁ between 0 and 1, and comparing σ and σ₁; in response to a being larger than σ₁, proceeding to a second strategy phase, or in response to σ being smaller than σ₁, proceeding to a first strategy phase;
S4, determining a judgment condition Pa1 for an exploration phase and an exploitation phase in the first strategy phase, where the judgment condition Pa1 adopts a nonlinear decay pattern;
S5, updating the positions during the exploration phase and the exploitation phase in the first strategy phase based on different conditions;
S6, using Brownian motion strategy and Levy flight strategy to perform a position update of a reference point during an exploration phase and an exploitation phase in the second strategy phase;
S7, based on a judgment condition Pa2 for the exploration phase and the exploitation phase in the second strategy phase, determining a formula of the position update for the second strategy phase and using a sine cosine operator to perform position perturbation update, with Pa2=0.4 as a reference value; and
S8, determining whether a current iteration number t is less than a maximum iteration number; in response to the current iteration number t being less than the maximum iteration number, performing the S3; in response to the current iteration number t being not less than the maximum iteration number, outputting a minimum value of an objective function as a minimum cost of the welded beams.

Whether to execute the first strategy phase or the second strategy phase depends on a relationship between σ and σ₁, σ<σ₁, the first strategy phase will be executed; otherwise, the second strategy phase will be executed. Specific details are as follows:

(1) The first strategy phase: foraging and storage strategy.

When φ>Pa1 entering the exploration phase, choose the following formula:

$${X}_{i}^{t + 1} = \{ \begin{matrix}{X}_{i , j}^{t} , {τ}_{1} < {τ}_{2} \\ \{ \begin{matrix}{X}_{m , j}^{t} + γ ( {X}_{A , j}^{t} - {X}_{B , j}^{t} ) + μ ( {r}^{2} * {U}_{j} - {L}_{j} ) , t \leq \frac{T}{2} \\ {X}_{C , j}^{t} + μ ( {X}_{A , j}^{t} - {X}_{B , j}^{t} ) + μ ( {r}_{1} < δ ) * ( {r}^{2} * {U}_{j} - {L}_{j} ) , t > \frac{T}{2}\end{matrix} , Otherwise\end{matrix}$$

Otherwise, enter the exploitation phase and choose the following formula:

$${X}_{i}^{t + 1 ( new )} = \{ \begin{matrix}{X}_{i}^{t} + μ * ( {X}_{best}^{t} - {X}_{i}^{t} ) * \vert λ \vert + {r}_{1} ( {X}_{A}^{t} - {X}_{B}^{t} ) & , {τ}_{1} < {τ}_{2} \\ {X}_{best}^{t} + μ * ( {X}_{A}^{t} - {X}_{B}^{t} ) , & {τ}_{1} < {τ}_{3} \\ {X}_{best}^{t} * l , & Otherwise\end{matrix}$$

Among them, X_{A,j}^{t} [symbol] X_{B,j}^{t} [symbol] X_{C,j}^{t} represents that A, B and C are three different indices (that is, three different positions) randomly selected from the population, so as to facilitate the exploration of high-quality seed sources; Both τ₁ [symbol] τ₂ [symbol] r₁ [symbol] r₂ [symbol] r₃ and r are random real numbers generated within the range of [0, 1]; X_{m,j}^{t} represents a mean value of the t-th dimension of all solutions in the j-th iteration; l represents a linearly decreasing factor from 0 to 1 in the exploitation phase; μ consists of function values of a normal distribution τ₄, a function values of the Lévy flight τ₅ a random real numbers τ₃ between [0, 1]. For specific details, see the following formula:

$$μ = \{ \begin{matrix}{τ}_{3} & {r}_{1} < {r}_{2} \\ {τ}_{4} & {r}_{2} < {r}_{3} \\ {τ}_{5} & {r}_{1} < {r}_{3}\end{matrix}$$

(2) The second strategy phase: Cache-search and recovery strategy.

When ϕ>Pa2 entering the exploration phase, choosing the following formula:

$${X}_{i}^{t + 1} = \{ \begin{matrix}{X}_{i , j}^{t} , & {τ}_{3} < {τ}_{4} \\ {X}_{i , j}^{t} + {r}_{1} * ( {X}_{best , j}^{t} - {X}_{i , j}^{t} ) + {r}_{2} * ( {RP}_{i , 1}^{t} - {X}_{C , j}^{t} ) , & Otherwise\end{matrix}$$

Otherwise, entering the exploitation phase and choose the following formula:

$${X}_{i}^{t + 1} = \{ \begin{matrix}{X}_{i , j}^{t} , & {τ}_{3} < {τ}_{4} \\ {X}_{i , j}^{t} + {r}_{1} * ( {X}_{best , j}^{t} - {X}_{i , j}^{t} ) + {r}_{2} * ( {RP}_{i , 2}^{t} - {X}_{C , j}^{t} ) , & Otherwise\end{matrix}$$

Among them, X_{best}^{t} represents an optimal individual in the current population; X_{C,j}^{t} represents a nutcracker individual randomly selected from the population; r₁ [symbol] r₂ [symbol] τ₁ [symbol] r₁ [symbol] r₂ (i=1,2,3,4,5,6,7,8) are all random numbers between [0,1].

A parameter set of welded beams corresponding to the minimum cost of the welded beams is a current solution found in the current iteration number as an optimal solution for the welded beams.

In an embodiment, the Bernoulli map is expressed as follows:

$$x ( t + 1 ) = \{ \begin{matrix}\frac{x ( t )}{1 - λ} ( 0 < x ( t ) \leq 1 - λ ) \\ \frac{x ( t ) - ( 1 - λ )}{λ} ( 1 - λ < x ( t ) < 1 )\end{matrix}$$

where λ=0.518, x(t) represents an optimal value of a previous generation, x(t+1) represents an optimal value of a next generation, and t represents the current iteration number.

In an embodiment, the judgment condition Pa1 in the S4 is expressed as follows:

$$Pa 1 = \frac{1}{2} + \frac{1}{2} \times sin ( \frac{π}{2} + π \frac{t}{T} )$$

where t represents the current iteration number, and T represents the maximum iteration number.

Brownian Motion is a kind of random strategy, which simulates the irregular motion of particles suspended in a liquid or gas. Due to the thermal motion of liquid molecules in a liquid or gas, the particles are bombarded by liquid molecules from all directions. When they are impacted by these unbalanced collisions, a motion of the particles will constantly change direction, resulting in an irregular motion of the particles. A random model (mean value μ=0, variance value σ²=1 of Brownian motion at point x is as follows:

$${f}_{B} ( x , μ , σ ) = \frac{1}{\sqrt{2 \cdot π \cdot {σ}^{2}}} \cdot exp ( - \frac{{( x - μ )}^{2}}{2 \cdot {σ}^{2}} ) = \frac{1}{\sqrt{2 \cdot π}} \cdot exp ( - \frac{{x}^{2}}{2} ) ,$$

which is denoted as BM.

Lévy flight is a kind of non-Gaussian random walk process with Markov property, which is characterized by occasional long-range jumps. It has both small-scale movements and large-distance jumps. The small-scale movements can help the algorithm conduct local neighborhood searches and improve the optimization accuracy, while the long-distance jumps can perturb the positions of the population and assist the algorithm in exploration to jump out of the local optimum. Mantegna proposed an algorithm for generating random numbers following the Lévy distribution in 1994. The mathematical expression of Lévy flight is as follows:

$$Levy ( λ ) = \frac{μ}{{\vert v \vert}^{\frac{1}{χ}}}$$

which is denoted as Levy.

In the formula: a relationship λ between Levy(λ)˜t^{-λ} and X is as follows: λ=1+χ and 0<χ≤2, both μ and ν follow the normal distribution. Their definitions are shown in the following formula:

μ˜N(0,σ_{μ}²)

ν˜N(0,σ_{ν}²)

Among them, the variances σ_{μ} and σμ_{ν} are determined by the following formula

$${σ}_{μ} = {( \frac{Γ ( 1 + χ ) \cdot sin ( \frac{χ}{2} π )}{Γ ( \frac{1 + χ}{2} ) \cdot χ \cdot {2}^{\frac{χ - 1}{2}}} )}^{\frac{1}{χ}}$$

$${σ}_{v} = 1$$

Otherwise represents a selection of other angles.

The nutcrackers use a spatial memory strategy to locate their caches. Nutcrackers most likely use multiple objects as signals for a single cache, and assume that each cache has only two objects for simplicity. And defined these objects as Reference Points. PR_{i,1}^{it} represents the position of the first reference point of the nutcracker in the second strategic stage, and PR represents the position of the second reference point of the nutcracker in the second strategic stage.

In an embodiment, in the S6, formulas for performing the position update of the reference point are expressed as follows:
for a first half of an iteration period

$$( it \leq \frac{T}{2} ) ,$$

$${PR}_{i , 1}^{it} = \{ \begin{matrix}{x}_{i}^{t} + ( ( αcos ( {x}_{A}^{t} - {x}_{B}^{t} ) + α RP ) / 2 ) / 2 + BM ( θ = \frac{π}{2} ) \\ {x}_{i}^{t} + ( αcos ( {x}_{A}^{t} - {x}_{B}^{t} ) ) / 2 + BM ( otherwise )\end{matrix}$$

$${PR}_{i , 2}^{it} = \{ \begin{matrix}{x}_{i}^{t} + ( ( αcos ( ( U - L ) τ + L ) + α RP ) {U}_{2} ) / 2 + BM ( θ = \frac{π}{2} ) \\ {x}_{i}^{t} + ( αcos ( ( U - L ) t + L ) {U}_{2} ) / 2 + BM ( otherwise )\end{matrix}$$

for a second half of the iteration period

$$( it > \frac{T}{2} ) ,$$

$${PR}_{i , 1}^{it} = \{ \begin{matrix}{x}_{i}^{t} + ( ( αcos ( {x}_{A}^{t} - {x}_{B}^{t} ) + α RP ) / 2 ) / 2 + Levy ( θ = \frac{π}{2} ) \\ {x}_{i}^{t} + ( αcos ( {x}_{A}^{t} - {x}_{B}^{t} ) ) / 2 + Levy ( otherwise )\end{matrix}$$

$${PR}_{i , 2}^{it} = \{ \begin{matrix}{x}_{i}^{t} + ( ( αcos ( ( U - L ) τ + L ) + α RP ) {U}_{2} ) / 2 + Levy ( θ = \frac{π}{2} ) \\ {x}_{i}^{t} + ( αcos ( ( U - L ) t + L ) {U}_{2} ) / 2 + Levy ( otherwise )\end{matrix}$$

where α represents a tuning factor; τ represents a random number in an interval of [0,1]; xᵢ^{t}, x_{A}^{t}, and x_{B}^{t} represent a current optimal position, and a position of a first randomly selected nutcracker A and, a position of a second randomly selected nutcracker B, respectively; RP represents a random reference position; U and L represent an upper limiting value and a lower limiting value, respectively; U₂ represents a reference value of 0 or 1, θ represents a radian between 0 and π, when θ is π/2, the formulas for the first half of the iteration period are used, when θ is not equal to π/2, the formulas for the second half of the iteration period.

In an embodiment, in the S7, a formula for using the sine cosine operator to perform position perturbation update is expressed as follows:

$$x ( t + 1 ) = x ( t ) + {z}_{1} sin ( {z}_{2} ) \vert {z}_{3} {x}_{best} - x ( t ) \vert$$

where z₁=2(1−t T); z₂ represents a random number between 0 and 1 multiplied by 2π; z₃ represents is a random number between 0 and 1 multiplied by 2; and x_{best} represents the optimal solution.

In an embodiment, the intelligent optimization method for welded beams further includes:
after obtaining a parameter set of welded beams including a weld width h, a stiffener length l, a beam length t, and a beam width b corresponding to the minimum cost of the welded beams, then constructing welded beams of a steel structure building based on the parameter set of the welded beams, followed by constructing the steel structure building based on the welded beams.

Compared to the related art, the beneficial effects of the disclosure are as follows.

The disclosure utilizes MATLAB software for programming, analyzing the original NOA algorithm and the BSCNOA (an improved NOA), and compares their optimization effects with the GWA, WOA, and PSO. The results of the BSCNOA show better performance. The disclosure addresses the shortcomings of the Nutcracker Algorithm and applies the proposed algorithm to the optimization problem of welded beams, significantly reducing the cost of welded beams.

### BRIEF DESCRIPTION OF DRAWINGS

To more clearly illustrate the embodiments of the disclosure or the technical solutions in the related art, a brief introduction to the attached drawings required in the description of the embodiments or the related art will be provided below. It is evident that the attached drawings described below are merely exemplary. For those skilled in the art, without the need for creative effort, other implementation drawings can be derived based on the provided drawings.

The structures, proportions, sizes, etc., illustrated in the specification are solely for the purpose of complementing the content revealed in the specification, to enable those skilled in the art to understand and read it. They are not intended to limit the conditions under which the disclosure can be implemented, and thus do not have substantial technical significance. Any modification of structural embellishments, changes in proportion relationships, or adjustments in size, as long as they do not affect the efficacy and purpose that the disclosure can achieve, should still fall within the scope of the technical content in the disclosure.

FIG. 1 illustrates a flowchart of a method in the disclosure.

FIG. 2 illustrates a schematic diagram of a welded beam structure in an embodiment of in the disclosure.

### DETAILED DESCRIPTION OF EMBODIMENTS

To make the objectives, technical solutions, and advantages of the embodiments of the disclosure clearer, the following will provide a clear and complete description of the technical solutions in the embodiments of the disclosure. Apparently, the described embodiments are only part of the embodiments of the disclosure, not all of them. These descriptions are intended only to further illustrate the features and advantages of the disclosure, not to limit the scope of the claims of the disclosure. Based on the embodiments in the disclosure, all other embodiments obtained by those skilled in the art without creative effort are within the scope of protection of the disclosure.

The specific embodiments of the disclosure will be further described in detail with reference to the attached drawings and examples. The following examples are used to illustrate the disclosure, but not to limit the scope of the disclosure.

The terms “first,” “second,” etc., are used solely for descriptive purposes and should not be understood as indicating or implying relative importance or implying the number of the technical features being referred to. Therefore, features specified as “first,” “second,” etc., can explicitly or implicitly include one or more of such features. In the description of the disclosure, unless otherwise specified, the term “multiple” means two or more.

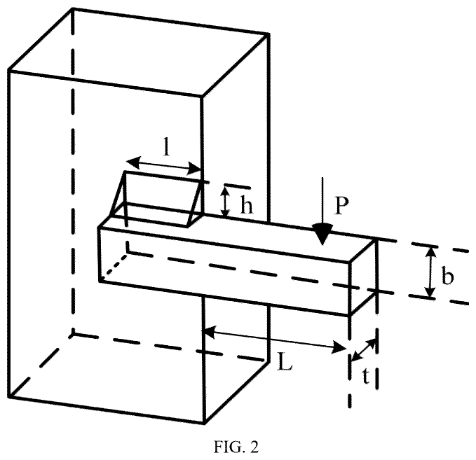

I. First, as shown in FIG. 2, a parameter set of the welded beams for the welded beam structure include a weld width h, a stiffener length 1, a beam length t, and a beam width b. A mathematical model of the welded beams is defined as:

x=[h,l,t,b]=[x₁,x₂,x₃,x₄]
where x represents a set of design solutions consisting of the four parameters for the welded beam structure, with units of inch, and upper limits and lower limits of the four parameters are: 0.1≤x₁≤2; 0.1≤x₂≤10; 0.1≤x₃≤10; 0.1≤x₄≤2.

An objective function of the welded beams is set to a cost of the welded beams expressed as follows:

$$f ( x ) = 1.10471 {x}_{1}^{2} {x}_{2} + 0.04811 {x}_{3} {x}_{4} ( 14. + {x}_{2} )$$

where a former part of 1.10471x₁²x₂ represents a cost of setting up a weld and a labor cost of welding, and a latter part of 0.04811x₃x₄(14.0+x₂) represents a material cost. The cost of setting up the weld and the labor cost of welding is a square of the weld width h multiplied by the stiffener length l, and further multiplied by the cost required per unit volume for setting up the weld and the labor, which is 1.10471. The material cost is the beam length t multiplied by the beam width b, further multiplied by a sum of length connected to a main body and the length from a load to a main part, which is 14 inches, and then multiplied by the cost required per unit volume of material, which is 0.04811, with units in US dollars.

Constraints are set as follows:
g₁(x)=τ(x)−τₘₐₓ, which represents a shear stress endured by the welded beams must not exceed a maximum limit value;
g₂(x)=σ(x)−σₘₐₓ, which represents a bending stress endured by the welded beams must not exceed a maximum limit value;
g₃(x)=δ(x)−δₘₐₓ, which represents an end deflection of the welded beams must not be less than 0.25;
g₄(x)=x₁−x₄≤0, which represents the weld width h must not be greater than the beam width b;
g₅(x)=P−P_{c}(x)≤0, which represents a critical load of buckling for the welded beams must not be less than a specified value P;
g₆(x)=0.125−x₁≤0, which represents the weld width h must not be less than a limit value of 0.125.
g₇(x)=0.10471x₁²+0.04811x₃x₄(14.0+x₂)−5≤0, which represents a total cost excluding the welding labor cost must not exceed 5;
more specific:

$$τ ( x ) = \sqrt{{( {τ}^{′} )}^{2} + 2 {τ}^{′} {τ}^{″} {x}_{2} / ( 2 R ) + {( {τ}^{″} )}^{2}} ;$$

$${τ}^{′} = P / ( \sqrt{2} {x}_{1} {x}_{2} ) ;$$

$${τ}^{″} = MR / J ;$$

$$M = P ( L + {X}_{2} / 2 ) ;$$

$$R = \sqrt{{x}_{2}^{2} / 4 + {( ( {x}_{1} + {x}_{3} ) / 2 )}^{2}} ;$$

$$J = 2 \{ \sqrt{2} {x}_{1} {x}_{2} [ {x}_{2}^{2} / 12 + {( ( {x}_{1} + {x}_{3} ) / 2 )}^{2} ] \} ;$$

$$σ ( x ) = 6 PL / ( {x}_{3}^{2} {x}_{4} ) ; δ ( x ) = 4 {PL}^{3} / ( {Ex}_{3}^{4} {x}_{4} ) ;$$

$$Pc ( x ) = 4.103 E \sqrt{{x}_{3}^{2} {x}_{4}^{6}} ( 1 - {x}_{3} \sqrt{E / ( 4 G )} / ( 2 L ) ) / {L}^{2} ;$$

where τ(x) represents the welding stress, σ(x) represents the bending stress, δ(x) represents a beam deformation, P represents a torque, Pc(x) represents the critical load for the buckling, τₘₐₓ, σₘₐₓ, and δₘₐₓ represent maximum values for the welding stress of 136 MPa, the bending stress of 30 MPa, and the beam deformation of 14 inches, respectively; and J, E, and G represent a polar moment of inertia with a value of 30×10⁶ Pa, a Young's modulus a value of 12×10⁶ Pa, and a shear modulus with a value of 6000 pounds per square inch (psi), respectively.

II. (1) Firstly, the use of the Bernoulli map in chaotic mapping instead of an original random population generation method makes the nutcracker population distribution more uniform and increases a diversity of the population. This provides a possibility of improving the optimization accuracy and jumping out of local optima in a next iteration process. A chaotic parameter λ is set to 0.518, x(t) represents an optimal value of the previous generation, x(t+1) represents an optimal value of a next generation, and t represents the current iteration number. The specific Bernoulli mapping is expressed as follows:

$$x ( t + 1 ) = \{ \begin{matrix}\frac{x ( t )}{1 - λ} ( 0 < x ( t ) \leq 1 - λ ) \\ \frac{x ( t ) - ( 1 - λ )}{λ} ( 1 - λ < x ( t ) < 1 )\end{matrix}$$

(2) Secondly, a linear decay pattern of Pa1 in the first strategy phase of NOA is optimized into a nonlinear decay pattern. This allows for slower convergence in the early stages of iteration, that is, in a first half of an iteration period,

$$( it \leq \frac{T}{2} ) ,$$

achieving better global exploration capabilities, and faster convergence in the later stages, that is, in a second half of the iteration period

$$( it > \frac{T}{2} ) ,$$

thereby accelerating the convergence speed of the algorithm.

The linear decay pattern of Pa1 is as follows:

$$Pa 1 = 1 - t / T ;$$

the nonlinear decay pattern used in the embodiment is as follows:

$$Pa 1 = \frac{1}{2} + \frac{1}{2} \times sin ( \frac{π}{2} + π \frac{t}{T} )$$

where t represents the current iteration number, and T represents the maximum iteration number.

(3) Brownian motion strategy and Levy flight strategy are used to perform position updates of the two reference points of PR₁ and PR₂, in the second strategy phase to help prevent the two reference points from falling into the local optima, thereby preventing the overall algorithm from becoming trapped in the local optima.

The Brownian motion strategy and the Levy flight strategy are used to perform the position updates of the reference points, which is expressed as follows:
for a first half of an iteration period

$$( it \leq \frac{T}{2} ) ,$$

$${PR}_{i , 1}^{it} = \{ \begin{matrix}{x}_{i}^{t} + ( ( α cos ( {x}_{A}^{t} - {x}_{B}^{t} ) + α RP ) / 2 ) / 2 + BM ( θ = \frac{π}{2} ) \\ {x}_{i}^{t} + ( α cos ( {x}_{A}^{t} - {x}_{B}^{t} ) ) / 2 + BM ( otherwise )\end{matrix} \\ {PR}_{i , 2}^{it} = \{ \begin{matrix}{x}_{i}^{t} + ( ( α cos ( ( U - L ) τ + L ) + α RP ) {U}_{2} ) / 2 + BM ( θ = \frac{π}{2} ) \\ {x}_{i}^{t} + ( α cos ( ( U - L ) τ + L ) {U}_{2} ) / 2 + BM ( otherwise )\end{matrix}$$

for a second half of the iteration period

$$( it > \frac{T}{2} ) ,$$

$${PR}_{i , 1}^{it} = \{ \begin{matrix}{x}_{i}^{t} + ( ( α cos ( {x}_{A}^{t} - {x}_{B}^{t} ) + α RP ) / 2 ) / 2 + Levy ( θ = \frac{π}{2} ) \\ {x}_{i}^{t} + ( α cos ( {x}_{A}^{t} - {x}_{B}^{t} ) ) / 2 + Levy ( otherwise )\end{matrix} \\ {PR}_{i , 2}^{it} = \{ \begin{matrix}{x}_{i}^{t} + ( ( α cos ( ( U - L ) τ + L ) + α RP ) {U}_{2} ) / 2 + Levy ( θ = \frac{π}{2} ) \\ {x}_{i}^{t} + ( α cos ( ( U - L ) τ + L ) {U}_{2} ) / 2 + Levy ( otherwise )\end{matrix}$$

where α represents a tuning factor; i represents a random number in an interval of [0,1]; xᵢ^{t}, x_{A}^{t}, and x_{B}^{t} represent a current optimal position, and a position of a first randomly selected nutcracker A and, a position of a second randomly selected nutcracker B, respectively; RP represents a random reference position; U and L represent an upper limiting value and a lower limiting value, respectively; U₂ represents a reference value of 0 or 1, θ represents a radian between 0 and π, when θ is π/2, the formulas for the first half of the iteration period are used, when θ is not equal to π/2, the formulas for the second half of the iteration period.

(4) A sine cosine operator is incorporated into the position updates of the second strategy to further enhance the population diversity and avoid the situation of falling into the local optima.

The position updates incorporated with the sine cosine operator is expressed as follows:

$$x ( t + 1 ) = x ( t ) + {z}_{1} sin ( {z}_{2} ) \vert {z}_{3} {x}_{best} - x ( t ) \vert$$

where z₁=2(1−t/T); z₂ represents a random number between 0 and 1 multiplied by 2π; z₃ represents a random number between 0 and 1 multiplied by 2; and x_{best} represents the optimal solution.

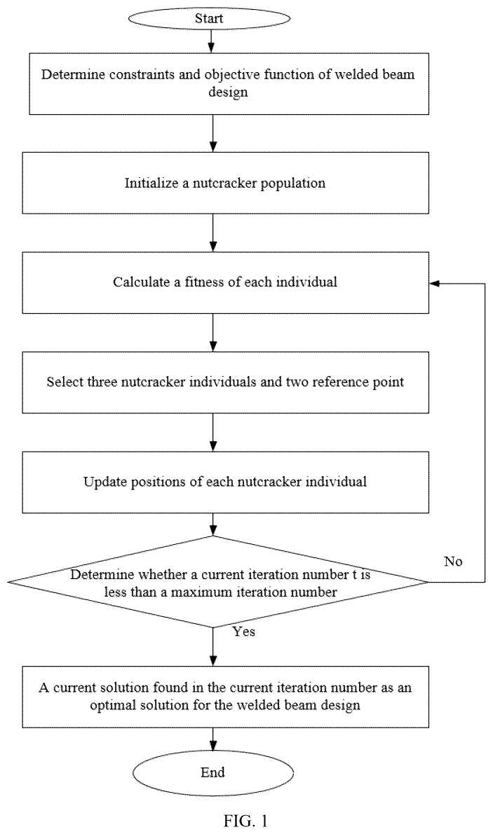

III. Based on I and II, an intelligent optimization algorithm (BSCNOA) is constructed using the four strategies from II to solve the objective function of the welded beams, resulting in the optimal solution for the welded beams. As shown in FIG. 1, the specific steps are as follows.

S1: the Bernoulli map obtained from II is utilized to initialize the nutcracker population to ensure a uniform distribution of the nutcracker population, which provides conditions for later optimization and escaping from the local optima.

S2: fitness of each individual in the nutcracker population (i.e., an objective function value of the welded beams) is calculated based on positions generated by the Bernoulli map and an optimal position in the positions generated by the Bernoulli map is selected.

S3: two values of σ, σ₁ between 0 and 1 are randomly generated, and two values of σ, σ₁ are compared. In response to σ being larger than σ₁, a second strategy phase is proceeded, or in response to σ being smaller than σ₁, a first strategy phase is proceeded.

S4: a judgment condition Pa1 adopts a nonlinear decay pattern, the judgment condition Pa1 for an exploration phase and an exploitation phase in the first strategy phase is determined as follows:

$$P a 1 = \frac{1}{2} + \frac{1}{2} \times sin ( \frac{π}{2} + π \frac{t}{T} ) .$$

S5: the positions during the exploration phase and the exploitation phase in the first strategy phase are updated based on different conditions. The Brownian motion strategy and the Levy flight strategy are used to perform the position updates of a reference point during the exploration phase and the exploitation phase in the second strategy phase, which is expressed as follows:

$$x ( t + 1 ) = x ( t ) + {z}_{1} sin ( {z}_{2} ) \vert {z}_{3} {x}_{best} - x ( t ) \vert$$

where z₁=2(1−t/T); z₂ represents a random number between 0 and 1 multiplied by 2π; z₃ represents a random number between 0 and 1 multiplied by 2; and x_{best} represents the optimal solution.

S6: whether a current iteration number t is less than a maximum iteration number is determined. In response to the current iteration number t being less than the maximum iteration number, the S3 is performed; in response to the current iteration number t being not less than the maximum iteration number, a minimum value of an objective function is output as a minimum cost of the welded beams. The parameters of the weld width h, the stiffener length 1, the beam length t, and the beam width b corresponding to the minimum cost of the welded beams is a current solution found in the current iteration number as an optimal solution for the welded beams.

In an illustrated embodiment, a pseudocode of the hybrid strategy intelligent optimization algorithm is as follows.
inputting: a population size N, a maximum iteration number T, an upper limit value U, a lower limit value L;
outputting: an optimal solution x_{best}, an optimal fitness f_{(xbest)}.

| | |
|---|---|
| 1. | initialize a nutcracker population using a Bernoulli map to ensure a uniform distribution of |

the nutcracker population

| | |
|---|---|
| 2. | calculate a fitness of each individual and select an optimal position |
| 3. | t=1 |
| 4. | While (t<T) |
| 5. | randomly generate two values of σ, σ1 between 0 and 1 |
| 6. | If σ<σ1 //* Foraging and storage strategies (i.e., the first strategy phase) // |
| 7. | randomly generate a value of ϕ |
| 8. | for i=1:N |
| 9. | for j=1:D |
| 10. | If φ>Pa1 /* exploration 1/ |
| 11. | Update xᵢ^{(t+1)} |
| 12. | else/* exploitation 1/ |
| 13. | Update xᵢ^{(t+1)} |
| 14. | end if |
| 15. | end for |
| 16. | Update a current iteration number t = t+1 |
| 17. | end for |
| 18. | else//* Cache search and retrieval strategy (i.e., the second strategy phase)// |
| 19. | Generate reference points using RP1 and RP2 formulas in an initial phase and a latter |

phase

| | |
|---|---|
| 20. | randomly generate a value between 0 and 1 |
| 21. | for i=1:N |
| 22. | If Ø>Pa2 /* exploration 2/ |
| 23. | Update xᵢ^{(t+1)} |
| 24. | else /* exploitation 2/ |
| 25. | update xᵢ^{(t+1)} |
| 26. | end if |
| 27. | t=t+1 |
| 28. | end for |

end while

In the embodiment, the hybrid strategy intelligent optimization algorithm (BSCNOA) is used for the relatively minimal cost of the welded beams, and its design effectiveness is compared with the WOA, GWO, and PSO. In the embodiment, the parameters are set as follows: the population size is 150, the maximum iteration number is 500, and a program is run 30 times. The output results are shown in Table 1.

TABLE 1
Comparison Table of Design Effects

| Algorithm | h | l | t | b | f(x) |
|---|---|---|---|---|---|
| BSCNOA | 0.667 | 2.4715 | 8.3562 | 0.667 | 1.66022 |
| NOA | 0.19883 | 3.3374 | 9.9192 | 0.19883 | 1.67022 |
| GWO | 0.19866 | 3.3524 | 9.1931 | 0.19885 | 1.67225 |
| WOA | 0.11757 | 15.9342 | 9.4467 | 0.19767 | 1.88146 |
| PSO | 0.19876 | 3.3396 | 9.1907 | 0.19891 | 1.67079 |

From Table 1, it can be seen that the BSCNOA algorithm uses hybrid strategies to optimize the four main design parameters of the welded beams, and ultimately calculates the minimum cost of the welded beams, which has a relatively better effect compared to the other four algorithms, resulting in a relatively optimal solution.

The above only provides a detailed explanation of the preferred embodiment in the disclosure, but this embodiment is not limited to the disclosure. Within the knowledge scope of those skilled in the art, various changes can be made without departing from the purpose of the disclosure, and all changes should be included in the scope of protection of the disclosure.

What is claimed is:

1. An optimization method for welded beams, comprising:
S1, initializing a nutcracker population by using a Bernoulli map to ensure a uniform distribution of the nutcracker population;
S2, calculating a fitness of each individual in the nutcracker population based on positions generated by the Bernoulli map and selecting an optimal position in the positions generated by the Bernoulli map;
S3, randomly generating two values of σ, σ₁ between 0 and 1, and comparing σ and σ₁;
in response to σ being larger than σ₁, proceeding to a second strategy phase, or in response to σ being smaller than σ₁, proceeding to a first strategy phase;
S4, determining a judgment condition Pa1 for an exploration phase and an exploitation phase in the first strategy phase, wherein the judgment condition Pa1 adopts a nonlinear decay pattern;
S5, updating the positions during the exploration phase and the exploitation phase in the first strategy phase based on different conditions;
S6, using Brownian motion strategy and Levy flight strategy to perform a position update of a reference point during an exploration phase and an exploitation phase in the second strategy phase;
S7, based on a judgment condition Pa2 for the exploration phase and the exploitation phase in the second strategy phase, determining a formula of the position update for the second strategy phase and using a sine cosine operator to perform position perturbation update, with Pa2=0.4 as a reference value; and
S8, determining whether a current iteration number t is less than a maximum iteration number; in response to the current iteration number t being less than the maximum iteration number, performing the S3; in response to the current iteration number t being not less than the maximum iteration number, outputting a minimum value of an objective function as a minimum cost of the welded beams, wherein a parameter set of welded beams corresponding to the minimum cost of the welded beams is a current solution as an optimal solution for the welded beams.

2. The optimization method for welded beams as claimed in claim 1, wherein the Bernoulli map is expressed as follows:
$$x ( t + 1 ) = \{ \begin{matrix}\frac{x ( t )}{1 - λ} ( 0 < x ( t ) \leq 1 - λ ) \\ \frac{x ( t ) - ( 1 - λ )}{λ} ( 1 - λ < x ( t ) < 1 )\end{matrix}$$
where λ=0.518, x(t) represents an optimal value of a previous generation, x(t+1) represents an optimal value of a next generation, and t represents the current iteration number.

3. The optimization method for welded beams as claimed in claim 1, wherein the judgment condition Pa1 in the S4 is expressed as follows:
$$P a 1 = \frac{1}{2} + \frac{1}{2} \times sin ( \frac{π}{2} + π \frac{t}{T} )$$
wherein t represents the current iteration number, and T represents the maximum iteration number.

4. The optimization method for welded beams as claimed in claim 1, wherein in the S6, formulas for performing the position update of the reference point are expressed as follows:
for a first half of an iteration period
$$( it \leq \frac{T}{2} ) ,$$
$${PR}_{i , 1}^{it} = \{ \begin{matrix}{x}_{i}^{t} + ( ( α cos ( {x}_{A}^{t} - {x}_{B}^{t} ) + α RP ) / 2 ) / 2 + BM ( θ = \frac{π}{2} ) \\ {x}_{i}^{t} + ( α cos ( {x}_{A}^{t} - {x}_{B}^{t} ) ) / 2 + BM ( otherwise )\end{matrix} \\ {PR}_{i , 2}^{it} = \{ \begin{matrix}{x}_{i}^{t} + ( ( α cos ( ( U - L ) τ + L ) + α RP ) {U}_{2} ) / 2 + BM ( θ = \frac{π}{2} ) \\ {x}_{i}^{t} + ( α cos ( ( U - L ) τ + L ) {U}_{2} ) / 2 + BM ( otherwise )\end{matrix}$$
for a second half of the iteration period
$$( it > \frac{T}{2} ) ,$$
$${PR}_{i , 1}^{it} = \{ \begin{matrix}{x}_{i}^{t} + ( ( α cos ( {x}_{A}^{t} - {x}_{B}^{t} ) + α RP ) / 2 ) / 2 + Levy ( θ = \frac{π}{2} ) \\ {x}_{i}^{t} + ( α cos ( {x}_{A}^{t} - {x}_{B}^{t} ) ) / 2 + Levy ( otherwise )\end{matrix} \\ {PR}_{i , 2}^{it} = \{ \begin{matrix}{x}_{i}^{t} + ( ( α cos ( ( U - L ) τ + L ) + α RP ) {U}_{2} ) / 2 + Levy ( θ = \frac{π}{2} ) \\ {x}_{i}^{t} + ( α cos ( ( U - L ) τ + L ) {U}_{2} ) / 2 + Levy ( otherwise )\end{matrix}$$
where α represents a tuning factor; τ represents a random number in an interval of [0,1]; xᵢ^{t}, x_{A}^{t}, and x_{B}^{t} represent a current optimal position, and a position of a first randomly selected nutcracker A and, a position of a second randomly selected nutcracker B, respectively; RP represents a random reference position; U and L represent an upper limiting value and a lower limiting value, respectively; U₂ represents a reference value of 0 or 1, θ represents a radian between 0 and π, when θ is π/2, the formulas for the first half of the iteration period are used, when θ is not equal to π/2, the formulas for the second half of the iteration period.

5. The optimization method for welded beams as claimed in claim 1, wherein in the S7, a formula for using the sine cosine operator to perform position perturbation update is expressed as follows:
$$x ( t + 1 ) = x ( t ) + {z}_{1} sin ( {z}_{2} ) \vert {z}_{3} {x}_{best} - x ( t ) \vert$$
where z₁=2(1−t/T); z₂ represents a random number between 0 and 1 multiplied by 2π; z₃ represents a random number between 0 and 1 multiplied by 2; and x_{best} represents the optimal solution.
